(19) United States
(12) Patent Application Publication
(10) Pub. No.: US 2003/0039342 A1
(43) Pub. Date: Feb. 27, 2003

(54) System, method, and apparatus for telephone messaging

(76) Inventor: Byron Yafuso, San Diego, CA (US)

Correspondence Address: Sarah Kirkpatrick, Intellectual Property Administration, QUALCOMM Incorporated, 5775 Morehouse Drive, San Diego, CA, 92121-1714, US

(21) Appl. No.: 09/940,341

(22) Filed: Aug. 27, 2001

(51) Int. Cl. H04M 1/64

(52) U.S. Cl. 379/88.19

(57) ABSTRACT

A message recorder permits non-sequential review of new or archived incoming messages. A filename generator generates a filename based on call identification information of an incoming telephone call. A storage interface allocates a region of a data storage to the incoming call and stores message data of the incoming call to the allocated region. Stored message data may be accessed via a corresponding filename rather than sequentially as in a conventional answering machine.

### BACKGROUND

1. Field

The present invention relates generally to telephony, and more specifically to telephone answering.

2. Background

Conventional telephone answering systems, such as answering machines and voice mail systems, store and reproduce incoming messages in the order received. However, it may be inconvenient for a user to review new incoming messages in such a sequential fashion. Likewise, it may be inconvenient for a user to access archived incoming messages sequentially. There is therefore a need in the art for non-sequential access to telephone messages.

### SUMMARY

Embodiments of the invention as disclosed herein address the above stated needs by generating a filename based on call identification information of an incoming telephone call, allocating a region of a data storage to the incoming call, and storing received message data of the incoming call to the allocated region. Information associating the filename with the allocated region may also be stored (e.g. to the data storage). Display of information relating to received incoming calls may also be displayed; in such embodiments, user input may be applied to select a displayed entry for non-sequential access to message data of the corresponding incoming call (e.g. for playback, forwarding, organization, and other operations as described herein).

### BRIEF DESCRIPTION OF THE DRAWINGS

FIG. 1 is a block diagram of a message recorder according to an embodiment of the invention;

FIG. 2A is diagram showing a directory organized as a table;

FIG. 2B is a diagram showing an i-node table;

FIG. 2C is a diagram showing a file allocation table;

FIG. 3 is a block diagram of a message recorder according to an embodiment of the invention;

FIG. 4 is a block diagram of a message recorder according to an embodiment of the invention;

FIG. 5 is a block diagram of a message recorder according to an embodiment of the invention;

FIG. 6 is a flow diagram for a method of message receiving according to an embodiment of the invention;

FIG. 7 is a flow diagram for a method of message receiving according to an embodiment of the invention;

FIG. 8 is a flow diagram for a method of message receiving according to an embodiment of the invention;

FIG. 9 is a flow diagram for a method of message receiving according to an embodiment of the invention;

FIG. 10 is a flow diagram for a method of message receiving according to an embodiment of the invention;

FIG. 11 is a block diagram of a message recorder according to an embodiment of the invention;

FIG. 12 is a block diagram of a message recorder according to an embodiment of the invention;

FIG. 13 is a block diagram of a message recorder according to an embodiment of the invention;

FIG. 14 is a block diagram of a message recorder according to an embodiment of the invention;

FIG. 15A shows a user interface of an implementation of a message recorder according to an embodiment of the invention;

FIG. 15B shows a user interface of an implementation of a message recorder according to an embodiment of the invention; and

FIG. 16 shows a user interface of an implementation of a message recorder according to an embodiment of the invention.

### DETAILED DESCRIPTION

The word “exemplary” is used exclusively herein to mean “serving as an example, instance, or illustration.” Any embodiment described herein as “exemplary” is not necessarily to be construed as preferred or advantageous over other embodiments.

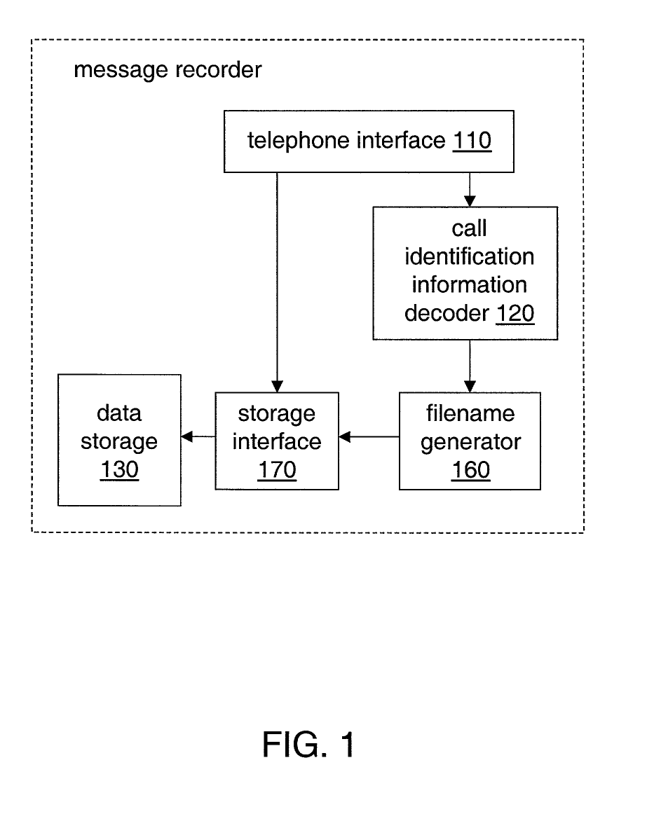

FIG. 1 shows a block diagram of a message recorder according to an embodiment of the invention. Telephone interface 110 receives incoming telephone call signals and provides such signals to other components of the message recorder in analog and/or digital form. In one implementation, telephone interface 110 is configured to be conductively coupled to the public switched telephone network (PSTN). For example, telephone interface 110 may include a two- or four-wire RJ11 jack to support a wired connection between the message recorder and the PSTN. In other configurations, telephone interface 110 may include one or more jacks or other terminals to support a wired connection to the PSTN via a coaxial cable and/or a shielded or unshielded twisted pair (UTP), possibly via another device (such as a computer) and/or another network (such as a local-area network). For example, telephone interface 110 may receive incoming telephone call signals over a digital datalink such as an Integrated Services Digital Network (ISDN), Digital Subscriber Line (DSL), RS-232, cable modem, Universal Serial Bus (USB), or IEEE-1394 (‘Firewire’) link. Telephone interface 110 may also include a jack to support a wired connection to a telephone or telephone handset.

In another implementation, telephone interface 110 is configured to be wirelessly coupled to the PSTN. For example, telephone interface 110 may include a wireless modem device configured to establish and maintain a connection to the PSTN via a base station of a network for cellular telephony or, alternatively, via a base station of a wireless local loop (WLL) network. Such a wireless modem and network might utilize one of the AMPS (Advanced Mobile Phone System), CDMA (code division multiple access), TDMA (time division multiple access), GSM, WCDMA, or cdma 2000 known in the art. In another case, telephone interface 110 may be coupled via a radio-frequency (RF) or optical (e.g. infrared) communications link to a cordless telephone station wired to the PSTN or to a cordless WLL telephone station wirelessly coupled to the PSTN.

Call identification information decoder 120 receives an incoming telephone call signal via telephone interface 110 and decodes call identification information of the incoming telephone call signal. In an exemplary implementation, the call identification information is received before the incoming call is answered. In one such example, the call identification information is supplied in accordance with an Automatic Number Identification (ANI) scheme [also called Calling Line Identification (CLI)]. In one ANI scheme, call identification information is transmitted over the same channel as the incoming call [e.g. using multifrequency (MF) or dual-tone MF (DTMF) tones]. In another ANI scheme, call identification information is transmitted in a data packet sent over another channel (e.g. of an ISDN connection).

In another example of call identification information received before the incoming call is answered, the call identification information is received in accordance with a Calling Number Delivery (CND) or ‘Caller ID’ service as described in such publications as TR-TSY-000030 (“SPCS Customer Premises Equipment Data Interface”), TR-TSY-000031 (“CLASS(sm) Feature: Calling Number Delivery”), and TA-NWT-001188 (“CLASS(sm) Calling Name Delivery and Related Features”) (Bellcore, now Telcordia, Morristown, N.J.) and revisions and updates thereto. In this case, the call identification information is frequency-shift-keying (FSK) modulated onto the incoming telephone call signal between the first and second rings. In a Single Data Message Format, the call identification information includes the calling number and the date and time of the call, and in a Multiple Data Message Format (also called ‘enhanced Caller ID’) the call identification information may also include the customer or business name under which the calling number is listed.

Filename generator 160 receives the call identification information and generates a file identifier (or ‘filename’) based on the call identification information. The filename may also include some or all of the calling number, date and time of the call, duration of the call, or a name or alias associated with the call identification information. Where appropriate, this information is either received from the PSTN along with the calling number or retrieved from a database within the message recorder. The message recorder includes a clock module (not shown) for determining the date, time, and duration of calls. Rather than being a separate module, the clock module may be incorporated into telephone interface 110, call identification information decoder 120, or within another part of the message recorder.

After the call identification information has been received, telephone interface 110 answers the incoming telephone call and provides message data of the incoming call (e.g. an audio message left by the caller) to a storage interface 170. Storage interface 170 allocates one or more regions (e.g. tracks, blocks, sectors, or clusters) of a data storage 130 to the incoming call and stores the message data to the allocated storage region or regions as a data file. Storage interface 170 also stores the filename to data storage 130 and associates it with at least one of the allocated storage region or regions.

Data storage 130 may include one or more magnetic, optical, phasechange, or magnetooptical media in disk, tape or other format and/or semiconductor devices such as static or dynamic random-access memory (RAM), flash RAM, or ferroelectric RAM. Such storage element or elements may be removable (e.g. a removable disk; a socketed semiconductor device; a PCMCIA storage device such as a flash card or microdrive; a flash card conforming to a standard such as CompactFlash, SmartMedia, or MemoryStick; etc.) or fixed (e.g. a fixed disk or soldered semiconductor device). Data storage 130 may also be organized as a storage hierarchy having two or more levels of storage elements distinguished by characteristics such as capacity, bus width, and access speed.

Filenames and message data files may be stored in different areas of data storage 130. For example, a specified set of regions of data storage 130 may be reserved for storage of filenames and association information (information associating each filename with one or more allocated storage regions). Alternatively, filenames and message data files may be stored in different regions of the same area of data storage 130. Particular implementations of storage interface 170 may store filenames and corresponding message data as files that comply with an operating system such as DOS File Allocation Table (FAT); OS/2 (IBM, New York, N.Y.); UNIX; Linux; MacOS (Apple, Cupertino, Calif.); Windows 95, 98, 2000, NT or CE (Microsoft Corporation, Redmond, Wash.); EPOC (Symbian Ltd., London, UK); and/or PalmOS (Palm, Inc., Santa Clara, Calif.).

Within data storage 130, the message data files may be stored in compressed form. For example, storage interface 170 may compress the message information using any of a variety of data compression algorithms before the information is stored within data storage 130. For example, message data may be compressed before storage using an algorithm based on a psychoacoustic model, such as MPEG Layer 3 or ‘MP3’ (MPEG LA, Denver, Col.). Alternatively, message data may be received in a compressed or coded form (e.g. linear predictive coded data received over a digital cellular telephone communications link) and stored directly with no decompression until playback of the data is selected. Additionally, telephone interface 110 may perform voice recognition functions such that message data can be stored in text form. For example, the message data may be stored in both text format and compressed or uncompressed audio format, allowing the user to later play back the message by either listening to or reading the message contents.

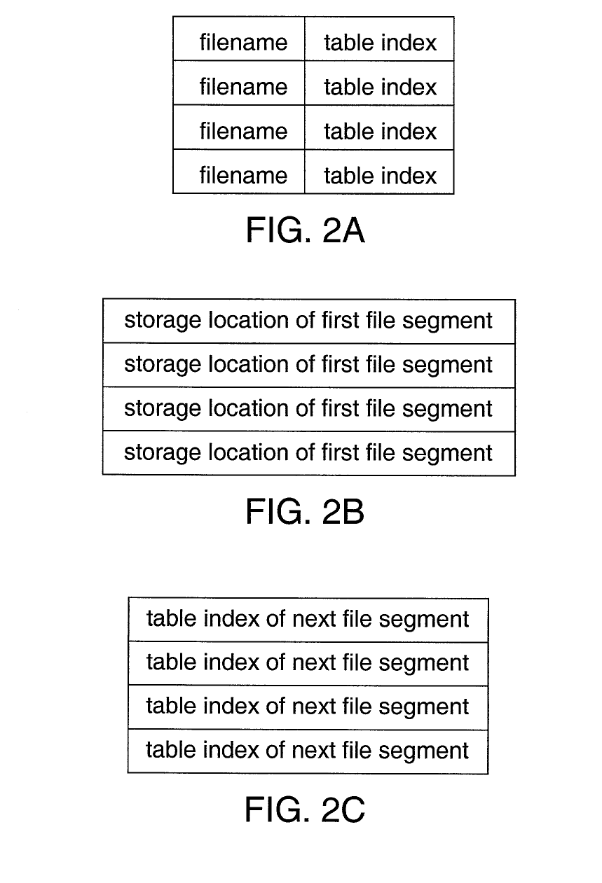

Filenames and corresponding association information may be stored within data storage 130 using any of a variety of organizational schemes. For example, the filenames and association information may be organized into one or more directories. A directory entry may include a filename and a location information portion that indicates a region allocated to the corresponding incoming call (i.e. a region storing message data of the incoming call). A directory entry may indicate the allocated region directly: for example, by identifying the sector or cluster of a disk or other storage device (e.g. flash card) at which the first portion of the message data is stored. Alternatively, the directory entry may indicate the allocated region indirectly. As shown in FIG. 2A, for example, a directory may be organized as a table, with each entry including an index into a mapping table [such as an i-node table as shown in FIG. 2B, or a file allocation table (FAT) as shown in FIG. 2C]. In such case, the corresponding mapping table entry includes or otherwise indicates a storage region allocated to the message data file (e.g. the location at which the file begins).

Directories may also be organized in a tree or other hierarchical structure, such that the location information portion of a directory entry may indicate the allocated region indirectly through a reference to another directory entry (possibly in a different directory). A directory entry may also indicate the name and location of another directory (e.g. on a lower hierarchical level) rather than the name and location of an individual data file.

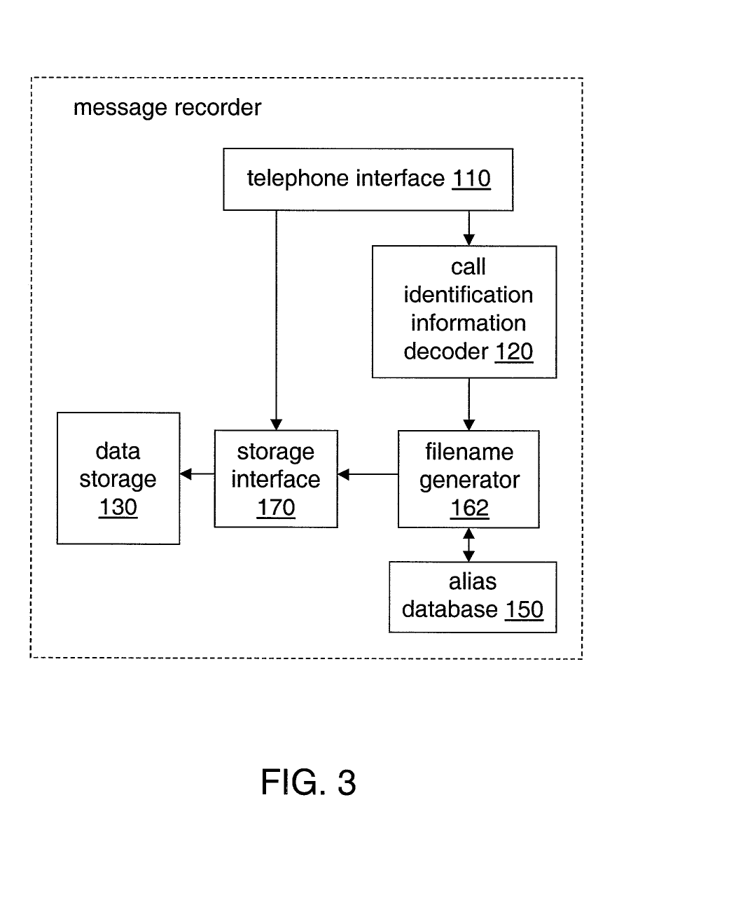

FIG. 3 shows an implementation of a message recorder according to an embodiment of the invention that includes an alias database 150. Alias database 150 stores preestablished correspondences between calling numbers and aliases, which may include personal names or nicknames or company names. Alias database 150 may reside on one or more storage elements, for example, as described above with respect to data storage 130. In one implementation, data storage 130 and alias database 150 include different regions of the same storage element or elements. Filename generator 162 receives the call identification information, retrieves a corresponding alias from alias database 150, and generates a filename based on the alias.

It may be desirable for the same alias to correspond to more than one number: for example, in a case where alias database 150 includes a cell phone number, office number, and home number for the same person. Likewise, more than one alias may be assigned to a calling number: for example, in a case where the number may be shared by several people, as in an office or PBX. In such case, voice recognition techniques and/or manual input by a user may be applied to the message data to assign the appropriate alias to a message data file.

As mentioned above, a filename may include information relating to the date and time of the incoming call. It may be possible for two calls to be received from the same calling number in close proximity such that both calls have the same calling number, date, and time. To ensure that each call record may be distinguished from all others, it may be desirable for a filename to include another distinguishing and/or identifying symbol. In one example, filename generator 160 maintains a counter which is updated (e.g. incremented) at each incoming call and whose value is incorporated into the filename for the incoming call. In another example, filename generator 160 determines whether the same filename already exists within data storage 130 (alternatively, the determination may be limited to the current directory). If the same filename is found, then the next symbol in a predetermined sequence (e.g. a counting number) may be appended or otherwise incorporated into the filename being generated. Alternatively, the date and time of each call that is included in the filename may include seconds, making it impossible for two calls to have the same filename. Other techniques for maintaining distinct filenames are also possible.

One or more among the units telephone interface 110, call identification information decoder 120, filename generator 160 or 162, alias database 150, or storage interface 170 as described herein may include one or more program modules or routines or other sequences of instructions executable by one or more microprocessors, digital signal processors, or other arrays of logic elements. In one implementation, a processor executes a sequence of instructions corresponding to one such unit at one time and a sequence of instructions corresponding to another such unit at another time. The practice and scope of the invention does not require such units to be distinct from one another, and in another implementation a processor may execute a sequence of instructions corresponding to more than one such unit.

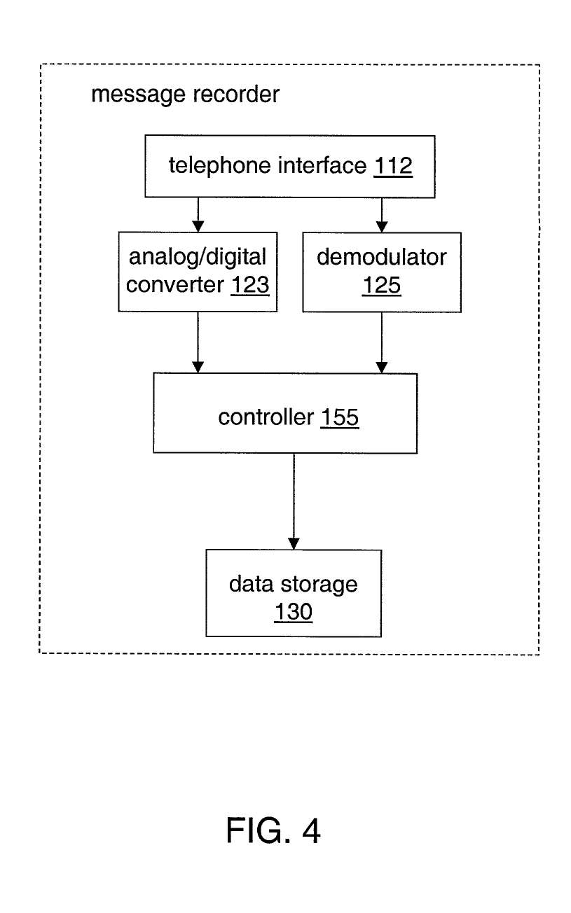

FIG. 4 shows an implementation of a message recorder according to an embodiment of the invention. In this example, telephone interface 112 supplies analog data to demodulator 125 and analog/digital converter 123. Before an incoming telephone call is answered, telephone interface 112 forwards the call signal to demodulator 125, which outputs a demodulated signal to controller 155. Controller 155 may include one or more microprocessors, digital signal processors, or other arrays of logic elements configured and arranged to execute one or more sequence of instructions as described above. Controller 155 extracts call identification information (such as Caller ID information) from the demodulated signal, possibly by performing operations such as start and stop detection, error detection decoding, and checksum calculation and verification. Controller 155 also allocates one or more regions of storage 135 to the incoming call.

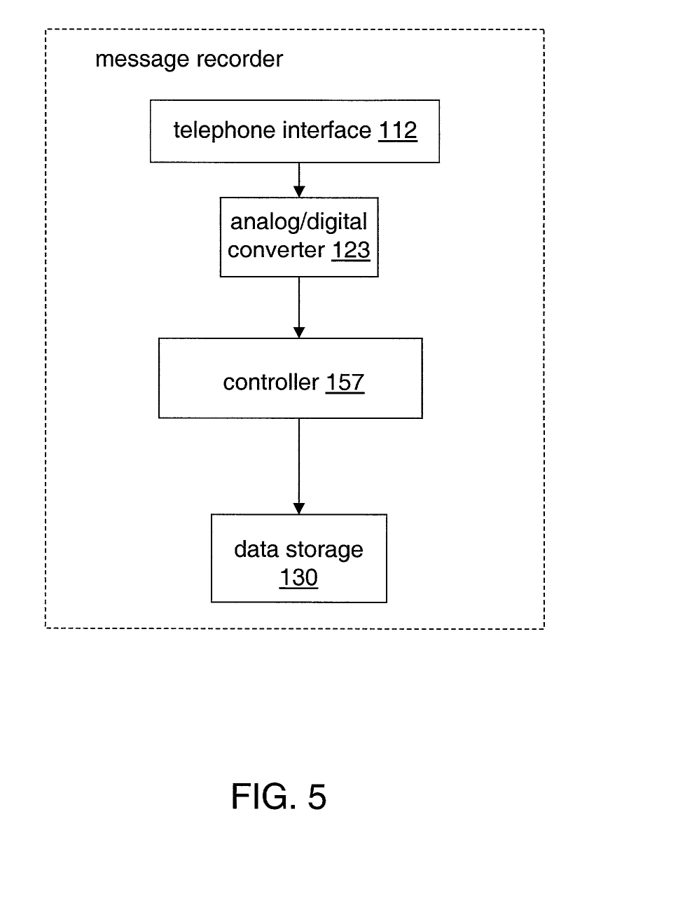

Via analog/digital converter 123, controller 155 receives the message data in digital form and stores it to the allocated regions of data storage 130. Controller 155 also creates a filename including at least a part of the call identification information and information that associates the filename with at least one of the allocated regions as described above, storing the entry to storage 135 (i.e. in this example, storage 135 includes both message data storage and filename storage). FIG. 5 shows another implementation of the message recorder in which a controller 157 performs the acts described above with respect to controller 155 and also demodulates a digital form of the call signal carrying call identification information. A telephone interface. such as telephone interface 110 discussed above, may also perform analog-to-digital conversion of a call signal before and/or after the incoming call is answered.

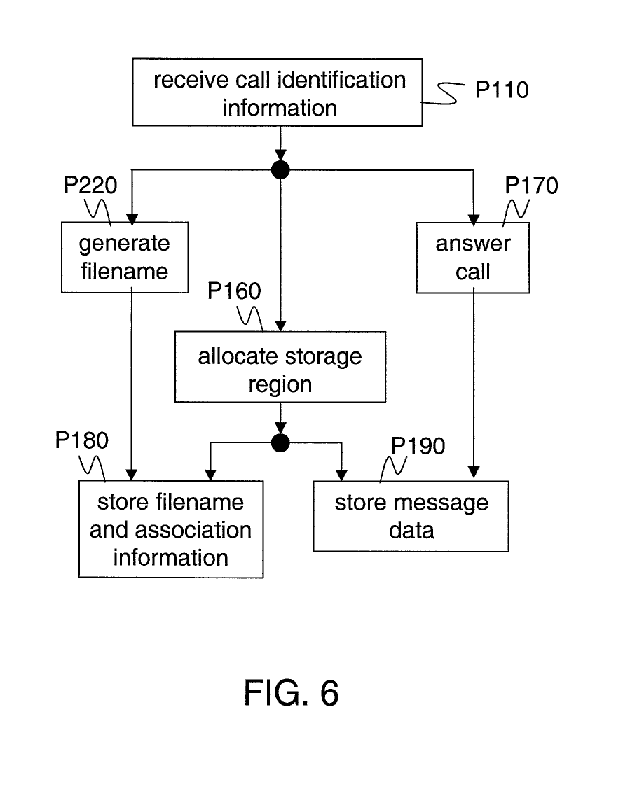

FIG. 6 shows a flow diagram for a method according to an embodiment of the invention. Task P110 receives call identification information of an incoming telephone call signal. Task P220 generates a filename based on the call identification information. For example, the filename may include the calling number or its listed name. The filename may also include the date and/or time of the call. Task P160 allocates at least one region of a data storage to the incoming call, and task P180 stores the filename and information, associating the filename with at least one of the allocated storage regions. Task P170 answers the call, and task P190 stores message data of the incoming call to the allocated storage region(s) of the data storage as a data file.

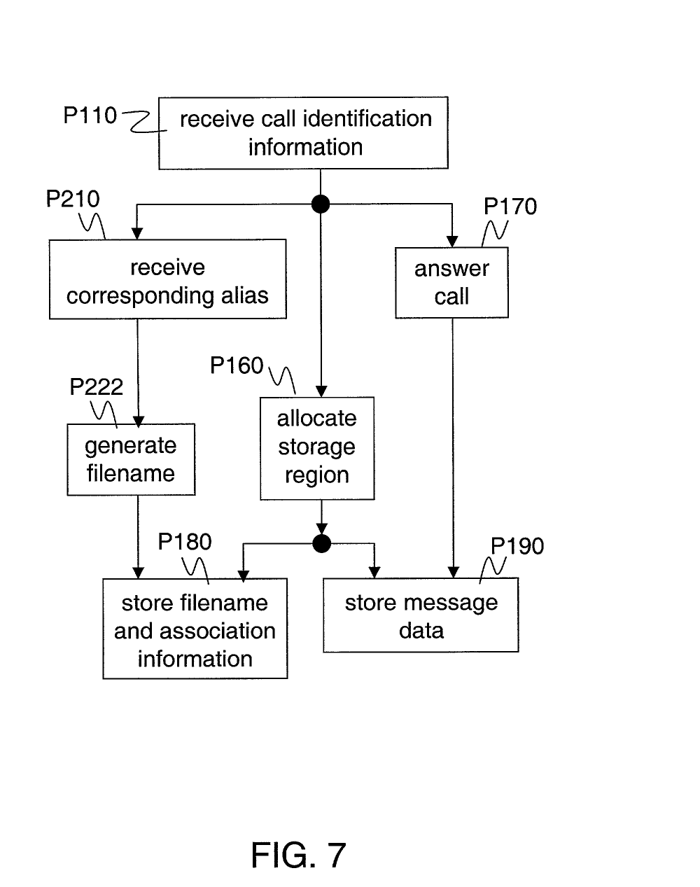

FIG. 7 shows a flow diagram for a method according to another embodiment of the invention. Task P210 receives an alias corresponding to the call identification information (e.g. an alias corresponding to the calling number). For example, an alias may be obtained by using a portion of the call identification information (e.g. the calling number or listed name) to reference an alias database. Task P222 receives the alias and produces a filename based on the alias. The filename may also include other information such as the date and/or time of the call.

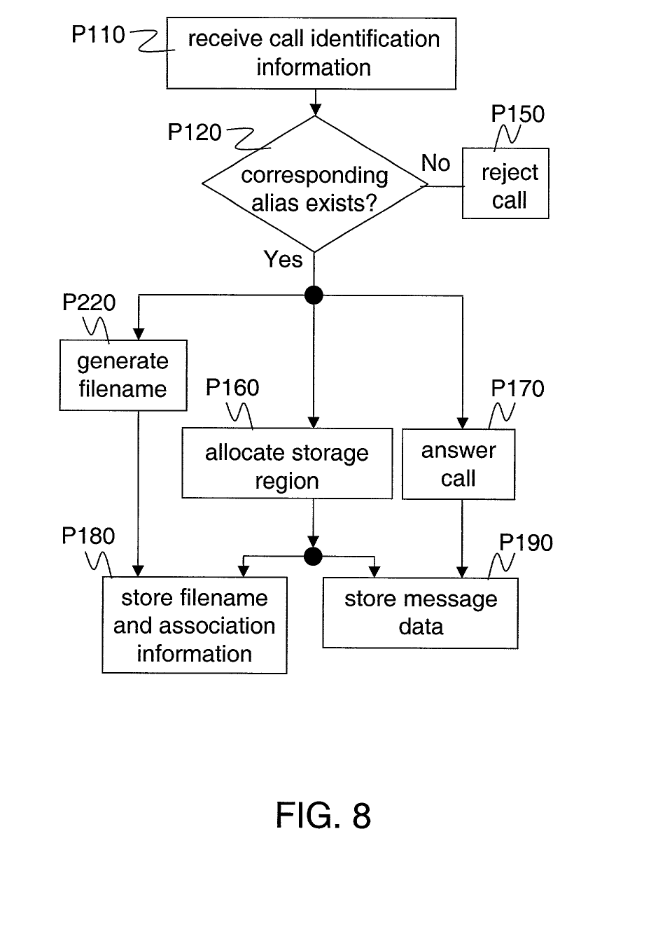

It may be desirable to reject some incoming calls without storing message data. FIG. 8 shows a flow diagram for a method according to one such embodiment of the invention. Task P120 determines whether an alias corresponding to the call identification information may be found. If no such alias is found, task P150 rejects the call. In one example, task P150 answers the call and immediately disconnects it. In another example, task P150 ignores the call and waits for the caller to give up. In another example, task P150 answers the call and plays a prerecorded or preprogrammed rejection message (e.g. stored in the data storage or another storage element).

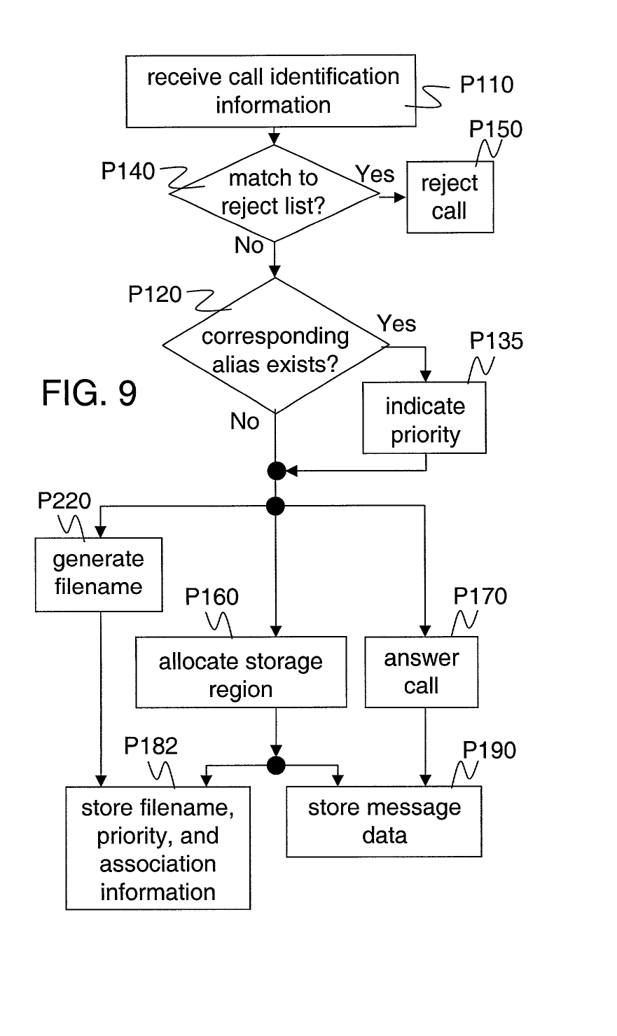

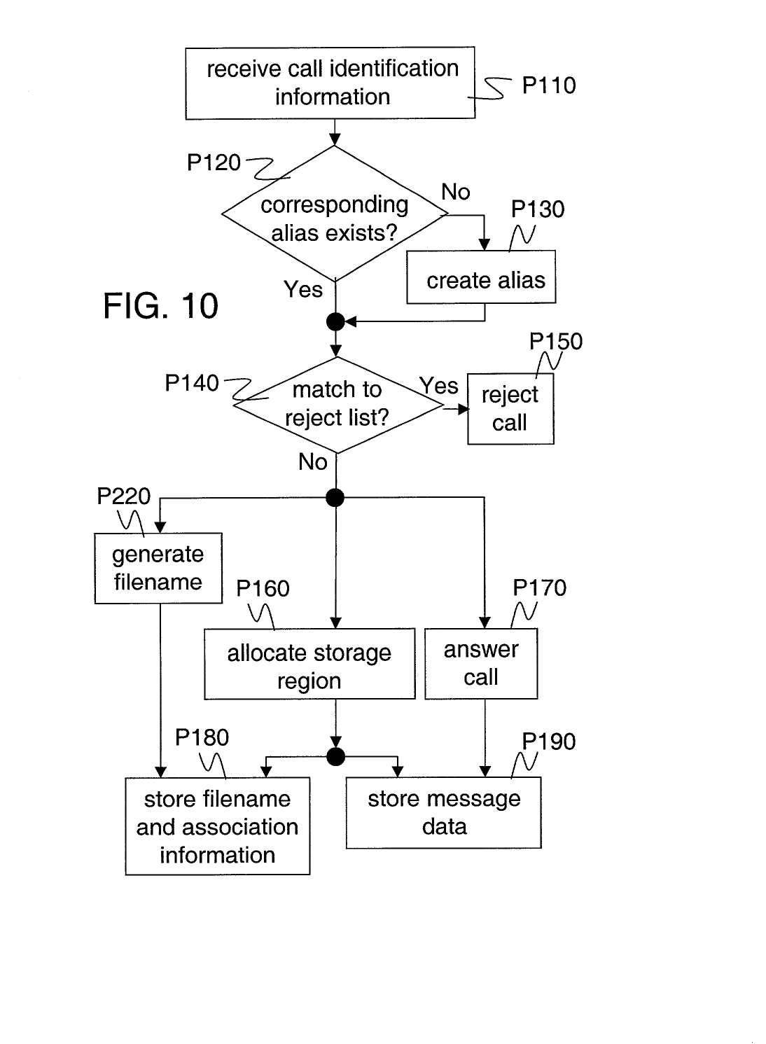

FIG. 9 shows a flow diagram for a method according to another embodiment of the invention. Task P140 determines whether a portion of the call identification information (e.g. the calling number or the listed name) matches any entry on a prestored reject list. If a match is found, task P150 rejects the call as described above. In another implementation, task P140 may be performed after an alias corresponding to the call identification information is found (e.g. as shown in FIG. 10), and the reject list may include aliases in addition to (or instead of) other identifiers. Even where a call is rejected, information such as the call identification information and the date and time of the attempted call may be stored or saved in task P150.

FIG. 9 also includes a task P135 that associates a priority to an incoming call based on the call identification information. For example, task P135 may associate a priority of one to the incoming call if the call identification information corresponds to an existing alias, and a priority of zero otherwise. In other implementations, task P135 may retrieve prestored priority information corresponding to the call identification information (e.g. from an alias database). Priority information may be used to configure or otherwise organize a display and/or playback of incoming messages as described below. In addition to the acts described above with respect to task P180, task P182 stores the priority information corresponding to the incoming call.

Priority and/or alias information corresponding to a particular string of call identification information may be entered by a user or downloaded from an external device such as a personal digital assistant (PDA) or a personal computer (PC). FIG. 10 shows a flow diagram for a method according to another embodiment of the invention that includes an alias creation task P130. If no corresponding alias is found in task P120, task P130 assigns a string of characters (e.g. the calling number and/or the listed name) to the incoming call as a temporary alias (e.g. until modification by a user). In a further implementation, task P130 may replace a numeric area, country, or local extension code in the temporary alias with the name of a geographical region corresponding to that code (e.g. as determined by reference to a database).

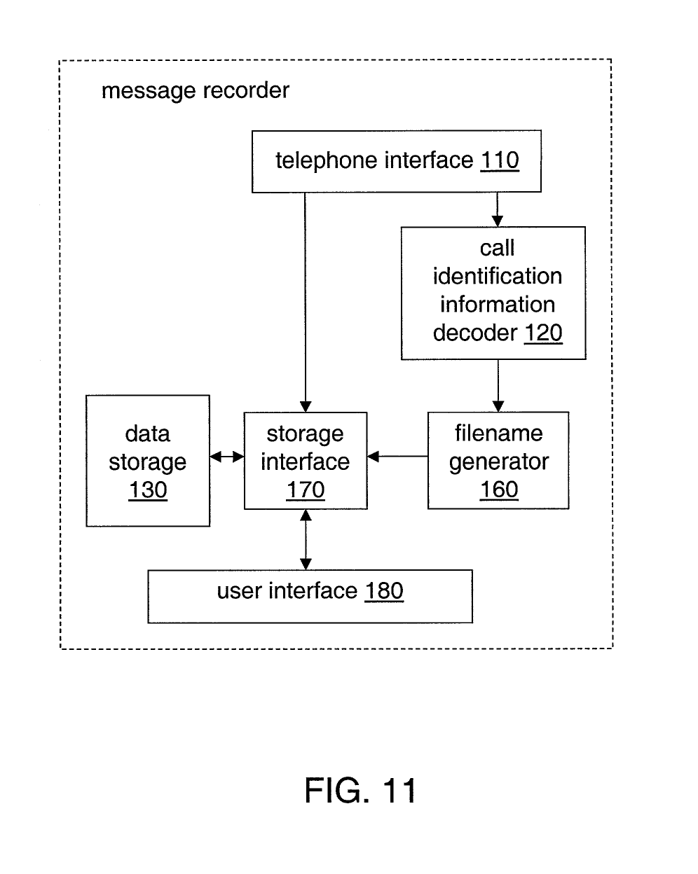

FIG. 11 shows a block diagram of a message recorder according to an embodiment of the invention. User interface (UI) 180 receives information relating to recorded incoming telephone calls from storage interface 170. For example, UI 180 may receive information including the calling number, listed name, priority information, and/or the time and/or length of the call. User interface (UI) 180 configures the information for presentation to a user [e.g. on an alphanumeric or graphical liquid crystal display (LCD), or cathode-ray tube (CRT) monitor or other flat panel display]. For example, UI 180 may configure the information for display in order of arrival of the calls. Alternatively, UI 180 may configure the information for display according to priority information of the calls.

UI 180 may include one or more processors such as microprocessors, digital signal processors, or other arrays of logic elements. UI 180 may also include memory for storing sequences of instructions to be executed by the one or more processors. The recorder may include a graphical display device; alternatively, UI 180 may include merely a connector to provide a display signal to an external display device [for example, a 9- or 15-pin connector for providing a Video Graphics Adapter (VGA)- or Super VGA (SVGA)-compliant signal, respectively].

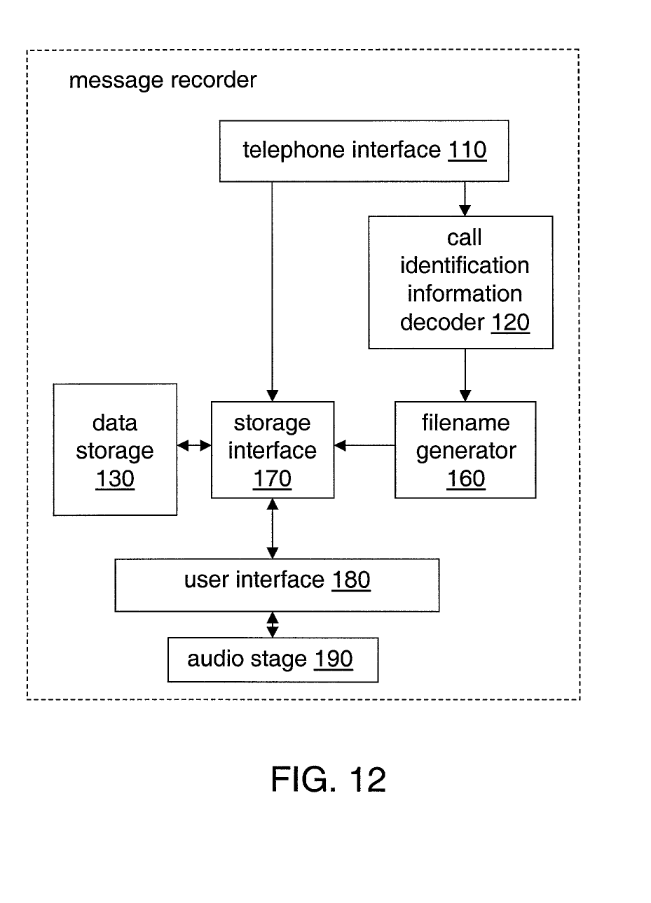

FIG. 12 shows a block diagram of a message recorder according to an embodiment of the invention. Audio stage 190 receives message data of an incoming call and reproduces the data as an audio signal. For example, audio stage 190 may perform operations such as digital-to-analog conversion and amplification on the message data. The audio signal may be output to an audio output device within a recorder such as a speaker (not shown). Audio stage 190 may include one or more terminals or jacks to support connection to a telephone or other audio output device.

In a further implementation, UI 180 receives audio data from audio stage 190 that is entered by a user. For example, audio stage 190 may perform operations such as amplification and analog-to-digital conversion of the audio data. UI 180 may provide audio data to data storage 130 or another storage area for later playback as an outgoing greeting (i.e. upon answering a call), or UI 180 may apply recognition techniques to the audio data to support voice-command control of the message recorder by a user. The audio data may be input via an audio input device within the recorder such as a microphone (not shown). Audio stage 190 may include one or more terminals or jacks to support connection to a telephone or other audio input device. Multiple outgoing greetings may be stored, with a particular outgoing message being selected for playback to incoming callers based on the caller's call identification information.

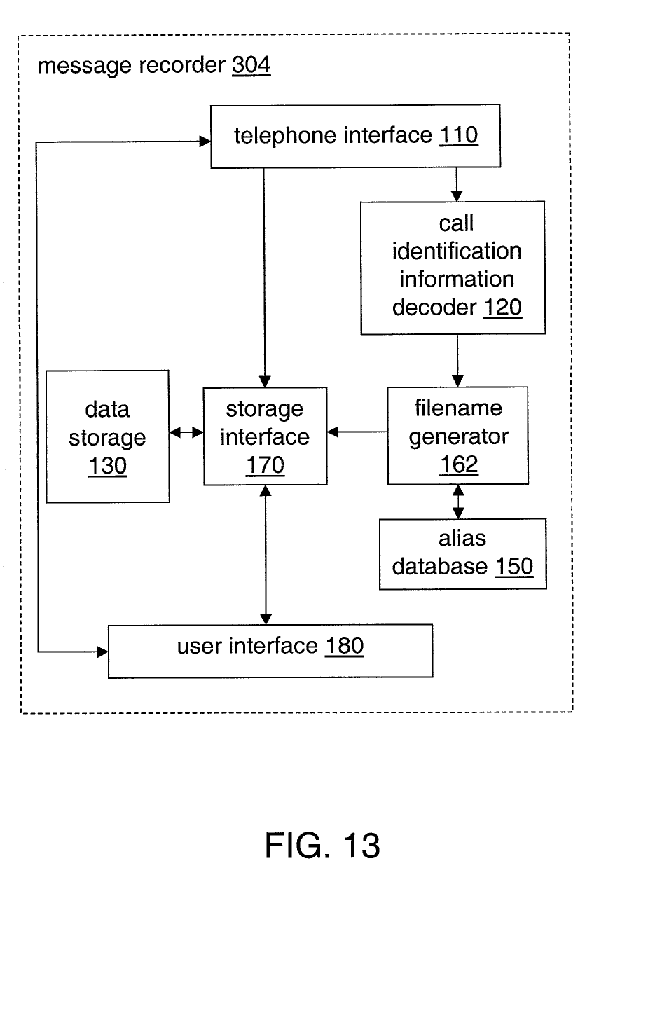

FIG. 13 shows a block diagram of a message recorder according to an embodiment of the invention. User interface (UI) 180 retrieves information from storage interface 170 and alias database 150 and configures the information for presentation to a user. In this case, information displayed for each recorded incoming call may include a corresponding alias instead of (or in addition to) the calling number and/or listed name. UI 180 may also provide message information to an external network in the form of e-mail, a wireless page, or other form of text terminal. Where telephone interface 110 performs voice recognition functions, message data may be stored in data storage 130 in text format. UI 180 then forwards some or all text message data to an external network. UI 180 can be configured to forward text information only for messages matching user-programmable criteria, such as messages received from a particular caller. UI 180 can also be configured to modify or edit forwarded text information, such as adding the alias or truncating all text after the first line. The user can also view the text contents of a stored message directly through a display.

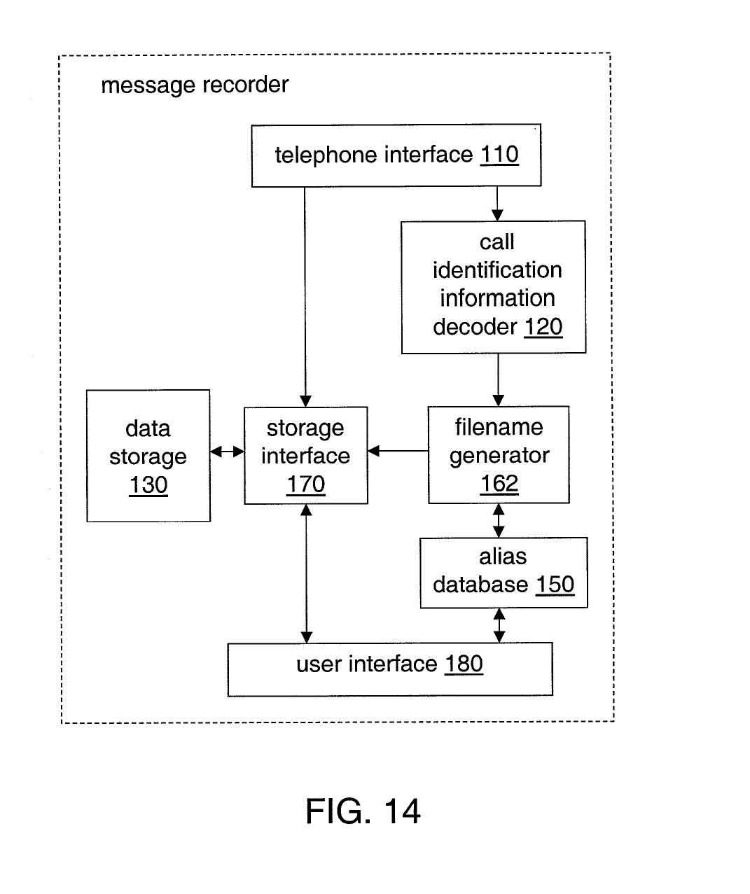

It may be desirable for a UI to receive and process user input to perform operations for user-directed display, organization, and/or playback of incoming calls. FIG. 14 shows a block diagram of a message recorder according to an embodiment of the invention. In response to user selection of a recorded incoming call from a displayed list, UI 180 performs playback of the selected call as described above. Unlike existing answering machines, the message recorder is not constrained to perform sequential access to recorded calls. In addition to the operations described above, UI 180 may also perform one or more of the following operations: Select a recorded incoming call for more detailed display, for deletion, for callback, or for forwarding.

Create and name directories; move recorded incoming calls between directories; select a directory for display of the associated recorded incoming calls.

Execute preprogrammed filters or rules to move recorded incoming calls into specified directories based on the call identification information and/or corresponding alias. This can be done either as each message comes in or may be triggered by user input into the UI.

Move a recorded incoming call (e.g. as a one-button or one-click operation) to a directory associated with a portion of the call identification information and/or the corresponding alias.

Sort displayed recorded incoming calls in order of date/time, calling number, listed name, alias, priority, message length, or other criteria.

Set a default directory for display; set a default directory for storage of incoming calls (e.g. root directory).

Initiate quick review of incoming calls (e.g. playback the first few seconds of each unreviewed recorded incoming call in the displayed list of calls).

Select a recorded incoming call for conversion to a text file (e.g. using a speech recognition engine); display the converted text.

Attach or add a text or audio (e.g. voice) annotation or comment; associate the annotation or comment with one or more recorded incoming calls. This can be done according to real time user input, such as after hearing playback of a stored message, or may be done automatically by the message recorder according to preprogrammed filters or rules.

Configuring answering operations such as recording outgoing greetings, setting one or more default aliases, creating and editing a reject list, setting reject criteria (e.g. no alias corresponding to received call identification information).

Alias database management operations such as entering an alias and associating the alias with one or more call identification information strings, associating one call identification information string with more than one alias, associating an alias with a directory, entering or modifying priority information corresponding to calling numbers or aliases, setting associations between prerecorded outgoing greetings and calling numbers or aliases.

User interface (UI) 180 may be configured to receive user input via a symbol input device such as a keyboard or keypad and/or a pointing device such as a mouse or trackball. In a further implementation, UI 180 may receive user input via movement of a stylus or the user's fingertip on a touch-sensitive (or proximity-sensitive) screen or other area. For example, UI 180 may be configured to allow a user to move message data files into directories by using a stylus or fingertip to drag displayed icons corresponding to the files into icons representing the desired directories.

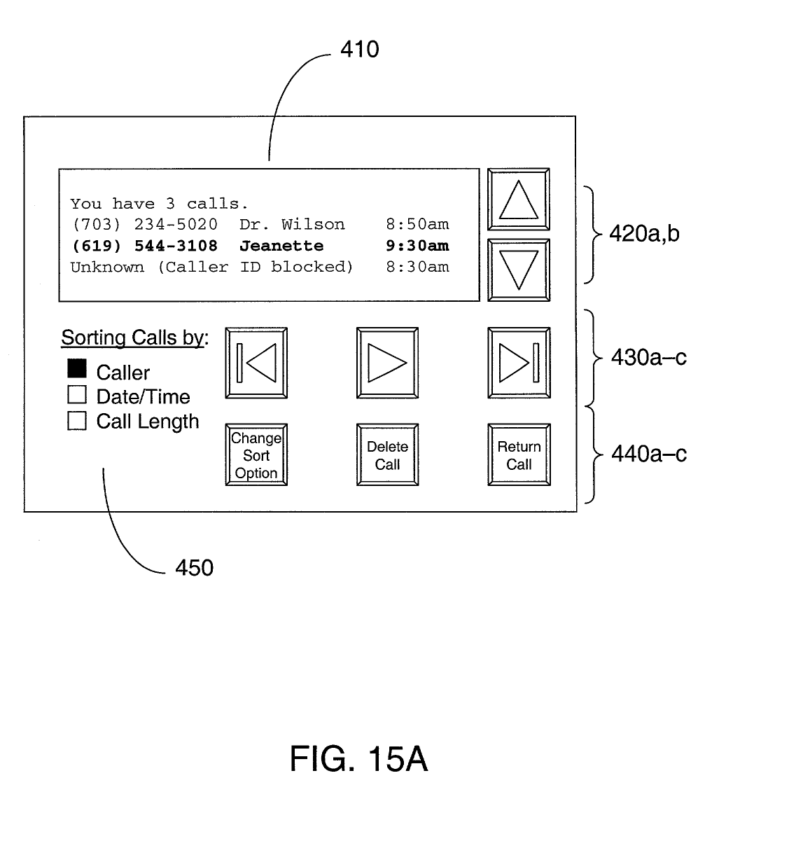

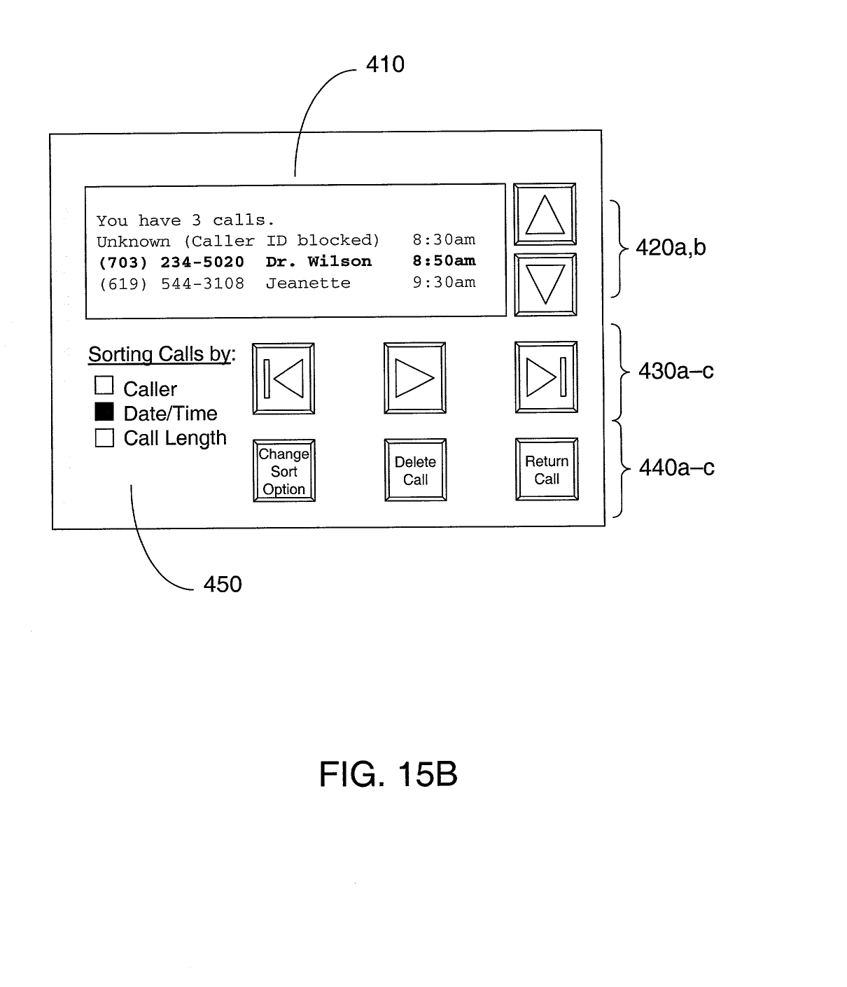

FIGS. 15A, B show a user interface of a message recorder according to an embodiment of the invention. A multiline alphanumeric display 410 (driven e.g. by a UI 180 as described above) displays call identification information or recorded incoming calls. In this example, the recorder is configured to select the third line displayed. This selection is indicated by displaying the third line in bold. Display control buttons 420a,b may be used to move the display window up and down through the list of recorded incoming calls. Play control button 430b initiates playback of the message data associated with the selected call, and play control buttons 430a and 430c move forward and backward, respectively, through the message data at an accelerated rate. Function buttons 440a-c control, respectively, scrolling through a list of display sort criteria, deleting the selected incoming call, and returning the selected call. Display sort indicator 450 indicates the criterion according to which the current display is sorted. For example, FIG. 15A shows a display of a list sorted according to alias, while FIG. 15B shows a display of the same list sorted according to date and time. Alternatively, the current sort criteria can be displayed within display 410.

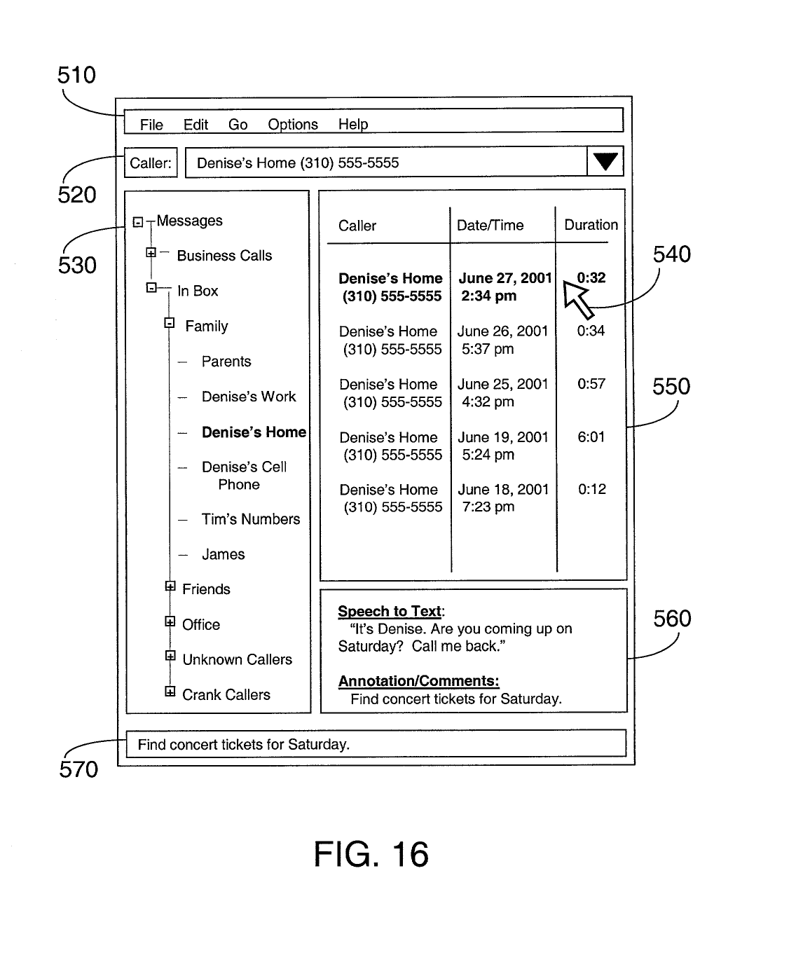

FIG. 16 shows a user interface of another implementation of a message recorder according to an embodiment of the invention. This user interface (e.g. as generated by a UI as described above) includes a menu bar 510 for command selection; a call information bar 520 to display information relating to a selected call, directory, or alias; organization frame 530 to display an organizational structure of recorded incoming calls; a pointer 540 to facilitate navigation of the interface by a user; a directory frame 550 to display a contents of a selected directory; a call summary frame 560 to display information relating to a selected recorded incoming call; and an annotation bar 570 for entry of annotations.

Although described primarily in terms of fixed or wireline configurations, the message recorders described herein may also be implemented to operated within a wireless network. For example, telephone interface 110 may receive incoming telephone call signals over a wireless connection such as provided within a cellular or PCS system.

A message recorder may be implemented as a standalone device or as an add-on module for an existing system such as a wireless remote station or personal computer. For example, a message recorder may take the form of a PCMCIA or PC-Card and accompanying software that can be installed into a laptop computer. Such a PCMCIA or PC-Card may include a wireless remote station or modem, with message data being stored on a hard drive or other laptop computer storage. Alternatively, the message recorder may be built into a wireless remote station or offered as a software enhancement to an existing remote station, with message data being stored in RAM, flash or other form of memory within the remote station. Where the remote station includes a vocoder, the vocoder may be used to compress the message data prior to storage, and used to decompress the message data during playback.

A message recorder may be implemented such that its functionality is split among different portions of a wireless communication system. For example, UI 180 might reside within a wireless remote station or terminal, with the remainder of the message recorder apparatus residing within a wireless base station, base station controller, or other wireless infrastructure apparatus. Such remainder within wireless infrastructure apparatus could provide such functions for multiple wireless remote stations. In addition, the message recorder functions may be allocated between wireless remote stations and infrastructure in a variety of other ways. In an embodiment, a wireless base station controller (BSC) receives incoming calls associated with a phone number assigned to a wireless remote station. If the remote station is busy, out of service, or if the call identification information appears on a reject list, the BSC services the call without sending the call information to the associated wireless remote station. Before storing the incoming call data, the BSC may compress the incoming call data using a vocoder, as would be used in an active wireless voice call. The compressed voice packets are then stored into the data storage 130 residing within the BSC. The BSC later notifies the wireless remote station of the new call data so that the user may retrieve the information. The BSC sends information to the wireless remote station to enable a user to view stored call information and select a call for playback. Upon playback, the BSC retrieves the already-compressed vocoder packets and sends them to the phone over a wireless connection.

Information and signals as discussed herein may be represented using any of a variety of different technologies and techniques. For example, data, instructions, commands, information, signals, bits, and symbols that may be referenced throughout the above description may be represented by voltages, currents, electromagnetic waves, magnetic fields or particles, optical fields or particles, or any combination thereof.

Moreover, the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The various acts to be performed in a method as described in connection with the embodiments disclosed herein may be embodied directly in hardware, in a software module executed by a processor, or in a combination of the two. Where appropriate, a sequence in which such acts are performed may be altered without departing from the scope of the invention. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. In the alternative, the processor and the storage medium may reside as discrete components in a device incorporating an embodiment of the invention.

The previous description of the disclosed embodiments is provided to enable any person skilled in the art to make or use the present invention. Various modifications to these embodiments are possible, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of recording an incoming message, said method comprising:
receiving call identification information of an incoming telephone call;
generating a filename based on the call identification information;
allocating a region of a data storage to the incoming telephone call;
receiving message data of the incoming telephone call; and
storing received message data to the allocated region.

2. The method of claim 1, wherein the call identification information includes a calling number, and
wherein said generating a filename based on the call identification information includes generating a filename based on the calling number.

3. The method of claim 1, wherein the call identification information includes at least one among a date and a time of the incoming telephone call, and wherein said generating a filename based on the call identification information includes generating a filename based on at least one among the date and the time of the incoming telephone call.

4. The method of claim 1, further comprising storing the filename.

5. The method of claim 1, further comprising answering the incoming telephone call,
wherein said receiving call identification information of an incoming telephone call occurs prior to said answering the incoming telephone call.

6. The method of claim 1, further comprising storing information associating the filename with the allocated region.

7. The method of claim 1, further comprising determining an alias corresponding to the call identification information,
wherein said generating a filename based on the call identification information includes generating a filename based on the alias.

8. The method of claim 1, further comprising comparing the call identification information to an entry of a reject list.

9. The method of claim 1, further comprising receiving call identification information of a plurality of incoming telephone calls, and
displaying a list of call information entries, each entry relating to one among the plurality of incoming telephone calls.

10. The method of claim 9, further comprising receiving a priority corresponding to each of the plurality of incoming telephone calls,
wherein said displaying a list of call information entries includes displaying the list of call information entries according to the priorities of the plurality of incoming telephone calls.

11. The method of claim 9, further comprising reproducing message data corresponding to a selected displayed call information entry.

12. The method of claim 1, wherein said storing received message data includes storing received message data within memory of a wireless phone.

13. The method of claim 1, wherein said storing received message data includes storing received message data within wireless infrastructure apparatus associated with a wireless phone associated with a phone number to which the incoming telephone call was placed.

14. The method of claim 1, wherein said storing received message data includes storing received message data into data storage residing within a portable computer.

15. A message recorder comprising:
a telephone interface configured and arranged to receive an incoming telephone call;
a decoder configured and arranged to output call identification information of the incoming telephone call;
a filename generator configured and arranged to generate a filename based on the call identification information;
a data storage having regions; and
a storage interface configured and arranged to allocate a region of the data storage to the incoming telephone call and to store received message data of the incoming telephone call to the allocated region.

16. The message recorder of claim 15, wherein the decoder is configured and arranged to output a calling number of the incoming telephone call, and
wherein the filename generator is configured and arranged to generate a filename based on the calling number.

17. The message recorder of claim 15, wherein the decoder is configured and arranged to output at least one among a date and a time of the incoming telephone call, and
wherein the filename generator is configured and arranged to generate a filename based on at least one among the date and the time of the incoming telephone call.

18. The message recorder of claim 15, wherein the telephone interface is configured and arranged to answer the incoming telephone call, and
wherein the decoder is configured and arranged to output call identification information of the incoming telephone call prior to an answering of the incoming telephone call by the telephone interface.

19. The message recorder of claim 15, wherein the storage interface is further configured and arranged to store the filename to the data storage.

20. The message recorder of claim 15, wherein the storage interface is further configured and arranged to store information associating the filename with the allocated region.

21. The message recorder of claim 15, further comprising an alias database having an alias corresponding to the call identification information,
wherein the filename generator is configured and arranged to receive the alias and to generate a filename based on the alias.

22. The message recorder of claim 15, wherein at least one of the telephone interface, the decoder, the filename generator, and the storage interface is further configured and arranged to compare the call identification information to an entry of a reject list.

23. The message recorder of claim 15, further comprising a user interface configured and arranged to display a list of call information entries,
wherein each of the call information entries relates to one of a plurality of received incoming telephone calls.

24. The message recorder of claim 23, wherein the user interface resides within a wireless remote station.

25. The message recorder of claim 23, wherein the user interface is further configured and arranged to receive a priority corresponding to each of the plurality of received incoming telephone calls and to display the list of call information entries according to the priorities of the plurality of incoming telephone calls.

26. The message recorder of claim 23, wherein the user interface is further configured and arranged to receive a user selection of one of the call information entries, and
wherein the storage interface is further configured and arranged to retrieve message data corresponding to the selected call information entry from the data storage.

27. The message recorder of claim 15, wherein the storage interface resides within a wireless infrastructure apparatus.

28. The message recorder of claim 15, wherein the telephone interface is wireless.

29. A data storage medium having machine-readable code, the machine-readable code including instructions executable by an array of logic elements, said instructions defining a method of recording an incoming message comprising:
receiving call identification information of an incoming telephone call;
generating a filename based on the call identification information;
allocating a region of a data storage to the incoming telephone call;
receiving message data of the incoming telephone call; and
storing received message data to the allocated region.

30. A message recorder comprising:
means for receiving call identification information of an incoming telephone call;
means for generating a filename based on the call identification information;
means for allocating a region of a data storage to the incoming telephone call;
means for receiving message data of the incoming telephone call; and
means for storing received message data to the allocated region.
